(19) United States
(12) Patent Application Publication
(10) Pub. No.: US 2026/0318773 A1
(43) Pub. Date: Oct. 15, 2026

(54) INSPECTION SYSTEM

(71) Applicant: TOYOTA JIDOSHA KABUSHIKI KAISHA, Toyota-shi (JP)

(72) Inventors: Daisuke KAKUMA, Numazu-shi (JP); Satoshi TAKAHASHI, Yokohama-shi (JP); Hiroya CHIBA, Fuji-shi (JP); Takeshi KANOU, Seto-shi (JP); Sen YANG, Susono-shi (JP); Kazuhiko UEDA, Tokyo (JP); Kento IWAHORI, Nagoya-shi (JP); Naufal Takbir IBRAHIM, Numazu-shi (JP)

(73) Assignee: TOYOTA JIDOSHA KABUSHIKI KAISHA, Toyota-shi (JP)

(21) Appl. No.: 19/530,828

(22) Filed: Feb. 5, 2026

(30) Foreign Application Priority Data
Apr. 11, 2025 (JP) 2025-065695

(51) Int. Cl. G01M 11/06

(52) U.S. Cl. CPC G01M 11/064; G01M 11/061; G01M 11/067

(57) ABSTRACT

The inspection system includes: a first mobile body including a lighting device to be inspected; a second mobile body that moves either in front of or behind the first mobile body; an imaging device mounted on either the first mobile body or the second mobile body and configured to capture a light beam emitted from the lighting device and output a captured image; an acquisition unit configured to acquire the captured image; and an inspection unit configured to inspect a function of the lighting device by using the captured image.

### CROSS-REFERENCE TO RELATED APPLICATION

This application claims priority to Japanese Patent Application No. 2025-065695 filed on Apr. 11, 2025. The disclosure of the above-identified application, including the specification, drawings, and claims, is incorporated by reference herein in its entirety.

### BACKGROUND

### 1. Technical Field

The present disclosure relates to inspection systems.

### 2. Description of Related Art

Conventionally, techniques are known in which, with the vehicle in a stopped state, the optical axis and luminous intensity of a headlamp mounted on the vehicle are inspected by using dedicated equipment installed at an inspection site such as a vehicle inspection station or a repair shop (see, for example, Japanese Unexamined Patent Application Publication No. 2022-37275 (JP 2022-37275 A)).

### SUMMARY

In conventional techniques, the functions of headlamps mounted on mobile bodies such as vehicles are inspected at dedicated sites using dedicated equipment. This situation is not limited to headlamps. The same applies when inspecting the functions of other lighting devices mounted on mobile bodies, such as other front lamps such as fog lamps, or rear lamps such as tail lamps.

The present disclosure can be implemented in the following forms
(1) One aspect of the present disclosure provides an inspection system. The inspection system includes: a first mobile body including a lighting device to be inspected; a second mobile body that moves either in front of or behind the first mobile body; an imaging device configured to capture a light beam emitted from the lighting device and output a captured image, the imaging device being mounted on either the first mobile body or the second mobile body; an acquisition unit configured to acquire the captured image; and an inspection unit configured to inspect a function of the lighting device by using the captured image. In this aspect, the inspection system utilizes travel of the mobile bodies in a convoy to capture the light beam emitted from the lighting device to be inspected. The inspection system can inspect the function of the lighting device mounted on the mobile body by using the captured image. With this configuration, the function of the lighting device mounted on the mobile body can be inspected without using a dedicated site or dedicated equipment.
(2) In the above aspect, the inspection system may further include an adjustment unit configured to adjust an optical system of the lighting device in accordance with an inspection result obtained by the inspection unit. In this aspect, the inspection system can automatically adjust the optical system of the lighting device in accordance with the inspection result. Accordingly, the number of personnel for adjustment work of the lighting device can be reduced.
(3) In the above aspect, the imaging device may be mounted on the second mobile body at a position facing the lighting device, and the imaging device may be configured to directly capture the light beam emitted from the lighting device. In this aspect, the function of the lighting device can be inspected by using a captured image obtained by directly capturing the light beam emitted from the lighting device to be inspected.
(4) In the above aspect, the second mobile body may include an irradiation plate that is mounted at a position facing the lighting device and that is irradiated with the light beam; the imaging device may be mounted on the first mobile body at a position facing the irradiation plate, and the imaging device may be configured to indirectly capture the light beam emitted from the lighting device by capturing the light beam incident on the irradiation plate. In this aspect, the function of the lighting device can be inspected by projecting, onto the irradiation plate, the light beam emitted from the lighting device to be inspected and using a captured image of the light beam projected onto the irradiation plate. As a result, even in a case where the imaging device is not mounted on the second mobile body, the inspection system can acquire captured images and inspect the function of the lighting device.
5) In the above aspect, either or both of the first mobile body and the second mobile body may be configured to move by unmanned driving, and the captured image may be captured during a period in which control for the unmanned driving is being executed. In this aspect, the function of the lighting device can be inspected while the mobile body is traveling by unmanned driving. The function of the lighting device can thus be inspected without stopping the mobile body. This improves the production efficiency and inspection efficiency of the mobile body. Moreover, the function of the lighting device can be inspected without an inspector having to get on the mobile body and operate the mobile body. Accordingly, the number of personnel for inspection of the lighting device can be reduced.
The present disclosure can be implemented in various forms other than the inspection system. For example, the present disclosure may be implemented as: a server or mobile body capable of implementing at least part of the functions of the inspection system; a method of manufacturing an inspection system; an inspection method using the inspection system; a method for controlling the inspection system; a computer program for implementing the control method; or a non-transitory recording medium storing the computer program.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram showing the configuration of an inspection system according to a first embodiment;

FIG. 2 is a block diagram showing the configuration of the inspection system;

FIG. 3 is a flowchart illustrating a processing procedure for travel control of a vehicle according to the first embodiment;

FIG. 4 is a flowchart showing an example of a processing procedure for implementing a method for inspecting a lighting device;

FIG. 5 illustrates a schematic configuration of an inspection system according to a second embodiment; and

FIG. 6 is a flowchart illustrating a processing procedure for travel control of a vehicle according to a second embodiment.

### DETAILED DESCRIPTION OF EMBODIMENTS

### First Embodiment

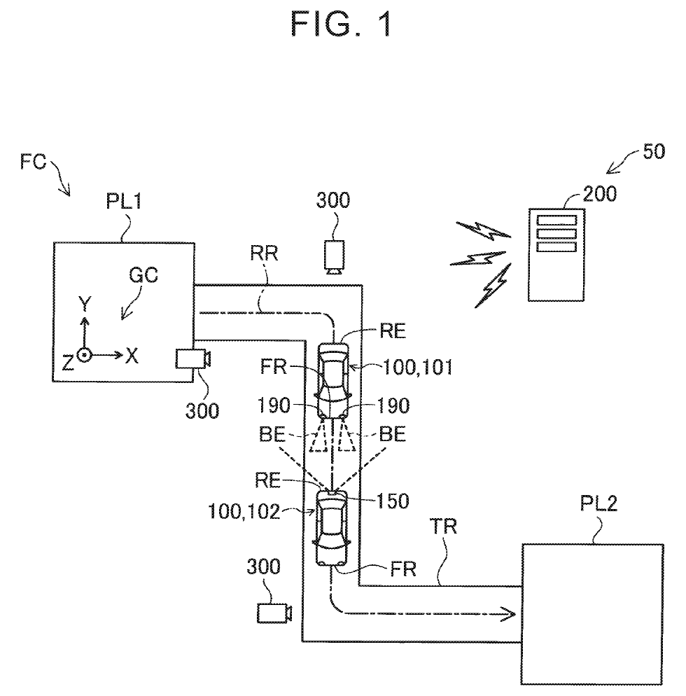

FIG. 1 is a conceptual diagram showing the configuration of an inspection system 50 according to a first embodiment. The inspection system 50 is a system that inspects the functions of a lighting device 190 mounted on a mobile body. The inspection system 50 includes a first vehicle 101 and a second vehicle 102 as mobile bodies, an imaging device 150, a server 200, and one or more external sensors 300.

The imaging device 150 is an in-vehicle camera that captures a light beam BE emitted from the lighting device 190 to be inspected and outputs a captured image. The imaging device 150 is mounted on either the first vehicle 101 or the second vehicle 102. The first vehicle 101 is a vehicle provided with the lighting device 190 to be inspected. The second vehicle 102 is a vehicle that travels either in front of or behind the first vehicle 101. The second vehicle 102 may be a vehicle on which a person can ride, such as a passenger car, or an unmanned transport vehicle such as an automated guided vehicle (AGV). The second vehicle 102 may travel in the same lane as the first vehicle 101 or in a different lane from the first vehicle 101. In the present embodiment, the lighting device 190 to be inspected is a headlamp mounted on the first vehicle 101. To directly capture the light beam BE emitted from the headlamp mounted on the front FR of the first vehicle 101, the imaging device 150 of the present embodiment is mounted on the rear RE of the second vehicle 102 traveling in front of the first vehicle 101. Hereinafter, when there is no need to distinguish between the first vehicle 101 and the second vehicle 102, they are simply collectively referred to as "vehicle 100."

In the present disclosure, the term "mobile body" refers to an object that can move, such as a vehicle or an electric vertical takeoff and landing aircraft (so-called flying car). A vehicle may be a vehicle that travels on wheels or a vehicle that travels on continuous tracks, and may be, for example, a passenger car, a truck, a bus, a motorcycle, a four-wheeled vehicle, or a construction vehicle. Vehicles include battery electric vehicles (BEVs), gasoline vehicles, hybrid electric vehicles, and fuel cell electric vehicles. When the mobile body is other than a vehicle, the terms "vehicle" or "car" used in the present disclosure may be replaced as appropriate with "mobile body," and the term "travel" may be replaced as appropriate with "move."

The vehicle 100 is capable of traveling by unmanned driving. The term "unmanned driving" refers to driving that does not rely on driving operations performed by an occupant. "Driving operations" refers to operations related to at least one of "moving," "turning," and "stopping" of the vehicle 100. Unmanned driving is implemented by automatic or manual remote control using a device located outside the vehicle 100, or by autonomous control of the vehicle 100. An occupant who does not perform driving operations may ride in the vehicle 100 that is traveling by unmanned driving. Examples of occupants who do not perform driving operations include a person who is merely seated in a seat of the vehicle 100, and a person who performs work different from driving operations, such as assembly, inspection, or operation of switches, while riding in the vehicle 100. Driving in which an occupant performs the driving operations is sometimes referred to as "manned driving."

In this specification, "remote control" includes "full remote control" in which all operations of the vehicle 100 are completely determined from outside the vehicle 100, and "partial remote control" in which part of the operations of the vehicle 100 are determined from outside the vehicle 100. "Autonomous control" includes "full autonomous control" in which the vehicle 100 autonomously controls its own operations without receiving any information from a device external to the vehicle 100, and "partial autonomous control" in which the vehicle 100 autonomously controls its own operations using information received from a device external to the vehicle 100.

In the present embodiment, the inspection system 50 is used in a factory FC where the vehicle 100 is manufactured. The reference coordinate system of the factory FC is a global coordinate system GC, and any position within the factory FC can be represented by X-, Y-, and Z-coordinates in the global coordinate system GC. The factory FC includes a first location PL1 and a second location PL2. The first location PL1 and the second location PL2 are connected by a travel path TR on which the vehicle 100 can travel. The vehicle 100 moves from the first location PL1 to the second location PL2 along the travel path TR by unmanned driving.

In the factory FC, the one or more external sensors 300 are installed along the travel path TR. The positions of the external sensors 300 in the factory FC are adjusted in advance. The external sensors 300 are sensors located outside the vehicle 100. In the present embodiment, the external sensors 300 are sensors that capture the vehicle 100 from outside the vehicle 100. Each external sensor 300 includes a communication device (not shown) and can communicate with other devices such as the server 200 via wired or wireless communication. Specifically, each external sensor 300 is implemented as a camera. A camera serving as an external sensor 300 captures the vehicle 100 and outputs a captured image as a detection result.

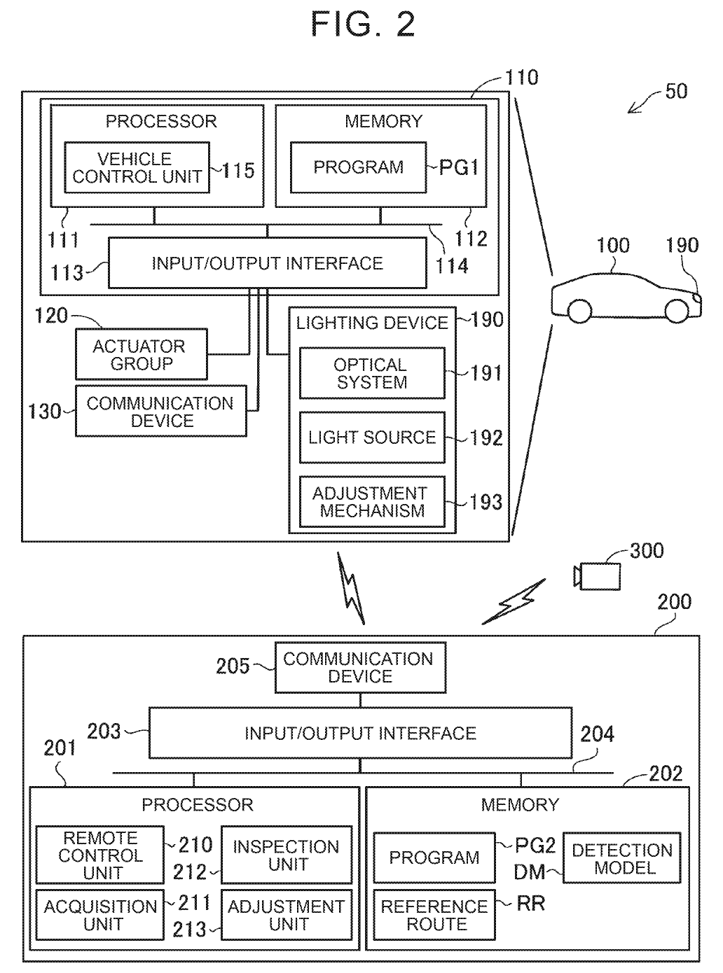

FIG. 2 is a block diagram illustrating the configuration of the inspection system 50. The vehicle 100 includes a vehicle control device 110 that controls various parts of the vehicle 100, an actuator group 120 including one or more actuators driven under control of the vehicle control device 110, and a communication device 130 that communicates with external devices such as the server 200 via wireless communication. The vehicle 100 further includes the lighting device 190 described above. The actuator group 120 includes an actuator of a drive device that accelerates the vehicle 100, an actuator of a steering device that changes the direction of travel of the vehicle 100, and an actuator of a braking device that decelerates the vehicle 100. The actuator group 120 further includes an actuator that operates the lighting device 190. The actuator of the lighting device 190 includes, for example, an actuator that switches the lighting device 190 on and off. The actuator of the lighting device 190 may further include an actuator that switches the operating mode of the lighting device 190 between a low beam mode and a high beam mode.

The lighting device 190 includes an optical system 191, a light source 192, and an adjustment mechanism 193. The optical system 191 collects light emitted from the light source 192 and emits the collected light to the outside of the lighting device 190. The optical system 191 includes, for example, a lens, a reflector, and a shade that collect light and emit the collected light. The optical system 191 further has a function of forming a cutoff line and an elbow point. The cutoff line is the light-dark boundary between an area irradiated with the light beam BE emitted from the lighting device 190 and an area not irradiated with the light beam BE. The elbow point is a point at which the cutoff line bends. The light source 192 may be, for example, a halogen lamp or a light-emitting diode (LED) lamp. The adjustment mechanism 193 is used to adjust the optical system 191. The adjustment mechanism 193 adjusts the optical axis of the lighting device 190 by adjusting, for example, the position or angle of the lens or the reflector included in the optical system 191. In the present embodiment, the adjustment mechanism 193 is configured as an electric adjustment mechanism and includes a motor that generates a driving force for changing the position or angle of the optical system 191, and a transmission mechanism that transmits the driving force of the motor to the optical system 191. As will be described later, in the present embodiment, the adjustment mechanism 193 is controllable by an adjustment unit 213 of the server 200.

The vehicle control device 110 is configured by a computer including a processor 111, a memory 112, an input/output interface 113, and an internal bus 114. The processor 111, the memory 112, and the input/output interface 113 are connected to each other via the internal bus 114 such that they can communicate with each other bidirectionally. The actuator group 120 and the communication device 130 are connected to the input/output interface 113. The processor 111 executes a program PG1 stored in the memory 112 to implement various functions including a function as a vehicle control unit 115.

The vehicle control unit 115 causes the vehicle 100 to travel by controlling the actuator group 120. The vehicle control unit 115 can cause the vehicle 100 to travel by controlling the actuator group 120 using a travel control signal received from the server 200. The travel control signal is a control signal for causing the vehicle 100 to travel. In the present embodiment, the travel control signal includes the acceleration and the steering angle of the vehicle 100 as parameters. In other embodiments, the travel control signal may include, instead of or in addition to the acceleration of the vehicle 100, the speed of the vehicle 100 as a parameter. The vehicle control unit 115 can also operate the lighting device 190 by controlling the actuator group 120 using an operation control signal received from the server 200. The operation control signal is a control signal for operating the lighting device 190, and is, for example, a signal for switching the lighting device 190 on and off, or a signal for switching the operating mode of the lighting device 190 between the low beam mode and the high beam mode. The vehicle control unit 115 can also adjust the optical system 191 of the lighting device 190 by controlling the adjustment mechanism 193 of the lighting device 190 using an optical system control signal received from the server 200. The optical system control signal is a control signal for operating the adjustment mechanism 193 of the lighting device 190 to adjust the optical system 191 of the lighting device 190.

The server 200 is configured by a computer including a processor 201, a memory 202, an input/output interface 203, and an internal bus 204. The processor 201, the memory 202, and the input/output interface 203 are connected to each other via the internal bus 204 such that they can bidirectionally communicate with each other. A communication device 205 that communicates with various devices outside the server 200 is connected to the input/output interface 203. The communication device 205 can communicate with the vehicle 100 via wireless communication and can communicate with each external sensor 300 via wired or wireless communication. The processor 201 executes a program PG2 stored in the memory 202 to implement various functions including functions as a remote control unit 210, an acquisition unit 211, an inspection unit 212, and an adjustment unit 213.

The remote control unit 210 acquires detection results from sensors, generates a travel control signal for controlling the actuator group 120 of the vehicle 100 using the detection results, and transmits the travel control signal to the vehicle 100, thereby causing the vehicle 100 to travel by remote control. The remote control unit 210 also generates an operation control signal for operating the lighting device 190 and transmits the operation control signal to the vehicle 100, thereby operating the lighting device 190 by remote control.

The acquisition unit 211 acquires a captured image from the imaging device 150 shown in FIG. 1. In the present embodiment, the acquisition unit 211 acquires a captured image obtained by directly capturing, with the imaging device 150 mounted on the rear RE of the second vehicle 102, the light beam BE emitted from the headlamp mounted on the front FR of the first vehicle 101. The captured image is preferably an image captured under conditions in which a range irradiated with the light beam BE emitted from the lighting device 190 can be easily identified when captured by the imaging device 150. For example, the captured image is preferably an image captured under conditions in which the captured image is less susceptible to backlighting from sunlight or to shadows caused by structures such as tunnels.

The inspection unit 212 shown in FIG. 2 inspects the functions of the lighting device 190 by using the captured image. For example, the inspection unit 212 inspects the optical axis of the lighting device 190 by using the captured image. When, as in the present embodiment, the lighting device 190 to be inspected is a headlamp, the inspection unit 212 inspects, for example, the optical axis of the light beam BE emitted in the low beam mode based on the position and height of the elbow point. Specifically, the inspection unit 212 detects the elbow point from the captured image of the light beam BE emitted from the headlamp operating in the low beam mode. The inspection unit 212 then identifies the separation distance and angular difference between the lighting device 190 to be inspected and the imaging device 150, based on the relative positional relationship between the first vehicle 101 and the second vehicle 102. Based on the identified separation distance and angular difference, the inspection unit 212 converts the elbow point on the captured image into the position coordinates or height of the elbow point under a predetermined inspection condition, such as a condition that the lighting device 190 illuminates 10 meters ahead. The inspection unit 212 thus obtains an inspection result. Whether the inspection of the optical axis passes or fails can be determined by comparing the inspection result of the optical axis with predetermined standards such as regulations of various countries.

The inspection unit 212 may inspect the light quantity of the lighting device 190 using the captured image. When, as in the present embodiment, the lighting device 190 to be inspected is a headlamp, the inspection unit 212 inspects, for example, the light quantity of the light beam BE emitted in the low beam mode, based on the light quantity at the elbow point. Specifically, the inspection unit 212 detects the elbow point from the captured image of the light beam BE emitted from the headlamp operating in the low beam mode. The inspection unit 212 then obtains an inspection result by converting the luminance of the pixels constituting the elbow point among the pixels constituting the captured image into an actual light quantity expressed in units such as candela (cd). Whether the inspection of the light quantity passes or fails can be determined by comparing the inspection result of the light quantity with predetermined standards such as regulations of various countries.

The inspection unit 212 may inspect functions of the lighting device 190 other than the optical axis and light quantity by using the captured image. For example, the inspection unit 212 may inspect the light color of the lighting device 190, such as white or pale yellow, by using the captured image, or may inspect the physical condition of the lighting device 190, such as cracks or fogging of the lens, by using the captured image. The inspection unit 212 may inspect the lighting state of the lighting device 190, such as whether the lighting device 190 turns on correctly, by using the captured image, or may inspect characteristics of the lighting device 190, such as the light quantity of the light beam BE emitted in the high beam mode, by using the captured image.

The adjustment unit 213 adjusts the optical system 191 of the lighting device 190 in accordance with the inspection result obtained by the inspection unit 212. The adjustment unit 213 generates an optical system control signal for controlling the adjustment mechanism 193 of the lighting device 190 and transmits the optical system control signal to the vehicle 100. The adjustment unit 213 thus operates the adjustment mechanism 193 of the lighting device 190 by remote control,and adjusts the optical system 191 of the lighting device 190.

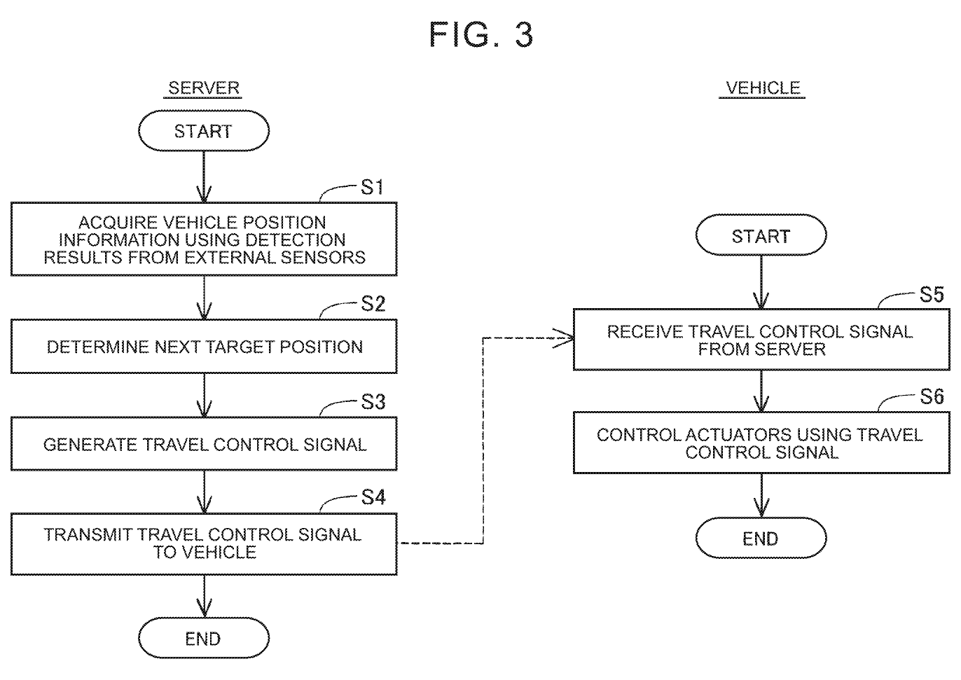

FIG. 3 is a flowchart illustrating a processing procedure for travel control of the vehicle 100 according to the first embodiment. In the processing procedure of FIG. 3, the processor 201 of the server 200 functions as the remote control unit 210 by executing the program PG2. The processor 111 of the vehicle 100 functions as the vehicle control unit 115 by executing the program PG1.

In step S1, the processor 201 of the server 200 acquires vehicle position information by using detection results output from the external sensors 300. The vehicle position information is position information that serves as a basis for generating a travel control signal. In the present embodiment, the vehicle position information includes the position and orientation of the vehicle 100 in the global coordinate system GC of the factory FC. Specifically, in step S1, the processor 201 acquires the vehicle position information by using captured images acquired from cameras serving as the external sensors 300.

More specifically, in step S1, the processor 201 detects the outline of the vehicle 100 from the captured images, calculates the coordinates of the positioning point of the vehicle 100 in a coordinate system of the captured images (a local coordinate system), and converts the calculated coordinates into coordinates in the global coordinate system GC, thereby acquiring the position of the vehicle 100. The outline of the vehicle 100 included in the captured images can be detected by, for example, inputting the captured images to a detection model DM that utilizes artificial intelligence. The detection model DM is, for example, prepared inside or outside the inspection system 50 and stored in advance in the memory 202 of the server 200. Examples of the detection model DM include a trained machine learning model that has been trained to implement either semantic segmentation or instance segmentation. For example, a convolutional neural network (CNN) that has been trained by supervised learning using a training dataset may be used as this machining learning model. The training dataset includes, for example, a plurality of training images containing the vehicle 100 and labels indicating, for each region in the training images, whether the region represents the vehicle 100 or represents something other than the vehicle 100. During training of the CNN, it is preferable that the CNN parameters be updated by backpropagation so as to reduce the error between the output of the detection model DM and the labels. The processor 201 can acquire the orientation of the vehicle 100 by, for example, using an optical flow method to estimate the orientation based on the direction of a motion vector of the vehicle 100 calculated from changes in the positions of feature points of the vehicle 100 between frames of the captured images.

In step S2, the processor 201 of the server 200 determines a target position to which the vehicle 100 should travel next. In the present embodiment, the target position is expressed by X-, Y-, and Z-coordinates in the global coordinate system GC. A reference route RR that is a route along which the vehicle 100 should travel is stored in advance in the memory 202 of the server 200. The route is represented by a node indicating a departure point, nodes indicating passing points, a node indicating a destination, and links connecting the nodes. The processor 201 determines, by using the vehicle position information and the reference route RR, the target position to which the vehicle 100 should travel next. The processor 201 determines the target position on the reference route RR ahead of the current position of the vehicle 100.

In step S3, the processor 201 of the server 200 generates a travel control signal for causing the vehicle 100 to travel toward the determined target position. The processor 201 calculates the traveling speed of the vehicle 100 from changes in the position of the vehicle 100 and compares the calculated traveling speed with a target speed. In general, when the traveling speed is lower than the target speed, the processor 201 determines an acceleration that causes the vehicle 100 to accelerate, and when the traveling speed is higher than the target speed, the processor 201 determines an acceleration that causes the vehicle 100 to decelerate. When the vehicle 100 is located on the reference route RR, the processor 201 determines a steering angle and an acceleration such that the vehicle 100 does not deviate from the reference route RR. When the vehicle 100 is not located on the reference route RR, in other words, when the vehicle 100 has deviated from the reference route RR, the processor 201 determines a steering angle and an acceleration such that the vehicle 100 returns to the reference route RR.

In step S4, the processor 201 of the server 200 transmits the generated travel control signal to the vehicle 100. The processor 201 repeatedly performs, at predetermined intervals, acquisition of the vehicle position information, determination of the target position, generation of the travel control signal, transmission of the travel control signal, and the like.

In step S5, the processor 111 of the vehicle 100 receives the travel control signal transmitted from the server 200. In step S6, the processor 111 of the vehicle 100 controls the actuator group 120 by using the received travel control signal, thereby causing the vehicle 100 to travel at the acceleration and steering angle indicated by the travel control signal. The processor 111 repeatedly performs, at predetermined intervals, reception of the travel control signal and control of the actuator group 120. The inspection system 50 of the present embodiment can cause the vehicle 100 to travel by remote control and can move the vehicle 100 without using transport equipment such as cranes or conveyors.

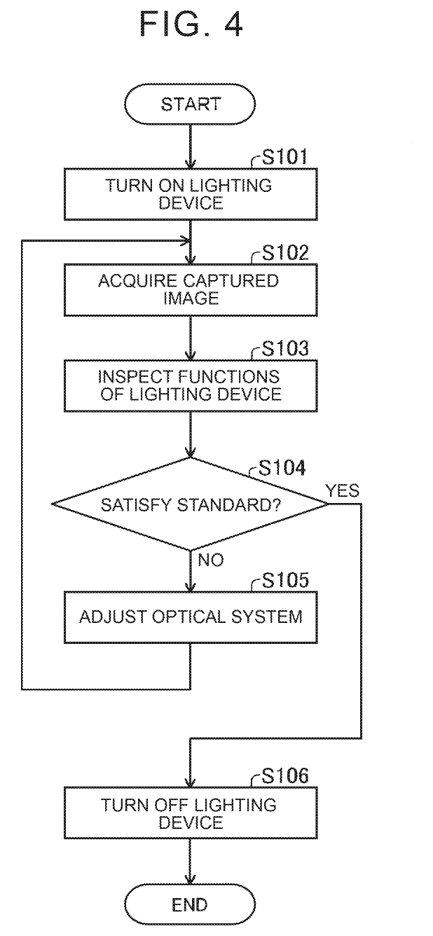

FIG. 4 is a flowchart showing an example of a processing procedure for implementing a method for inspecting the lighting device 190. In the processing procedure of FIG. 4, the processor 201 of the server 200 functions as the remote control unit 210, the acquisition unit 211, the inspection unit 212, and the adjustment unit 213 by executing the program PG2. The flow shown in FIG. 4 is executed, for example, during a period in which the first vehicle 101 and the second vehicle 102 move from the first location PL1 to the second location PL2 shown in FIG. 1 by unmanned driving, that is, during a period in which the first vehicle 101 and the second vehicle 102 travel along the travel path TR by unmanned driving.

In step S101, the processor 201 of the server 200 switches the lighting device 190 to be inspected from off to on. In step S102, the processor 201 of the server 200 acquires a captured image of the light beam BE emitted from the lighting device 190. In step S103, the processor 201 of the server 200 uses the acquired captured image to inspect the functions of the lighting device 190 represented in the captured image. When the inspection result does not satisfy a predetermined standard (step S104: No), step S105 is executed. In step S105, the processor 201 of the server 200 adjusts the optical system 191 of the lighting device 190 so as to reduce the difference from the predetermined standard. Thereafter, the processing returns to step S102, where the processor 201 of the server 200 acquires a captured image of the light beam BE emitted from the lighting device 190 after the adjustment. The processor 201 of the server 200 then inspects, in step S103, the functions of the lighting device 190 represented in this reacquired captured image. The processor 201 of the server 200 repeatedly executes steps S102 to S105 until a reinspection result satisfies the predetermined standard. When the inspection result satisfies the predetermined standard (step S104: Yes), step S106 is executed. In step S106, the processor 201 of the server 200 switches the lighting device 190 from on to off. This completes the flow. When the inspection result satisfies the predetermined standard (step S104: Yes), the lighting device 190 may be kept on without being switched from on to off.

In the first embodiment, the inspection system 50 utilizes travel of the vehicles 100 in a convoy to capture the light beam BE emitted from the lighting device 190 to be inspected. The inspection system 50 can inspect the functions of the lighting device 190 mounted on the vehicle 100 by analyzing the captured image. With this configuration, the functions of the lighting device 190 mounted on the vehicle 100 can be inspected without using a dedicated site or dedicated equipment. This allows flexible design of the layout of the inspection area in the factory FC where the lighting device 190 is inspected.

In the first embodiment, when the inspection result does not satisfy the standard, the inspection system 50 can automatically adjust the optical system 191 of the lighting device 190 by controlling the adjustment mechanism 193 of the lighting device 190. With this configuration, the optical system 191 of the lighting device 190 can be brought closer to the standard without a worker manually adjusting the optical system 191 of the lighting device 190. As a result, the number of personnel for post-inspection adjustment work can be reduced.

The inspection system 50 may not include the adjustment unit 213. At least part of the adjustment work may be performed manually by a worker. Even in such a configuration, the functions of the lighting device 190 mounted on the vehicle 100 can be inspected without using a dedicated site or dedicated equipment.

In the first embodiment, the imaging device 150 is mounted on the second vehicle 102 at a position facing the lighting device 190 to be inspected. With this configuration, the functions of the lighting device 190 can be inspected by using a captured image obtained by directly capturing the light beam BE emitted from the lighting device 190 to be inspected.

In the first embodiment, the lighting device 190 to be inspected is a headlamp mounted on the first vehicle 101. The imaging device 150 is mounted on the rear RE of the second vehicle 102 that travels in front of the first vehicle 101. With this configuration, the functions of the headlamp can be inspected by directly capturing, with the imaging device 150 mounted on the second vehicle 102 traveling ahead, the light beam BE emitted from the headlamp of the first vehicle 101 traveling behind.

The lighting device 190 to be inspected is not limited to a headlamp. The lighting device 190 to be inspected may be, for example, another front lamp such as a fog lamp, or a rear lamp such as a tail lamp. In this case, inspection items may differ depending on the type of the lighting device 190 to be inspected. For example, when the lighting device 190 to be inspected is a fog lamp, the light quantity may be inspected by comparison with a predetermined threshold, without inspecting the optical axis. The mounting position of the imaging device 150 may differ depending on the placement of the lighting device 190 to be inspected on the first vehicle 101 and the relative positional relationship between the first vehicle 101 and the second vehicle 102. For example, when the lighting device 190 to be inspected is a tail lamp mounted on the rear RE of the first vehicle 101, the imaging device 150 may be mounted on the front FR of the second vehicle 102 traveling behind the first vehicle 101.

In the first embodiment, both the first vehicle 101 and the second vehicle 102 are capable of traveling by unmanned driving Images are captured during a period in which control for unmanned driving is being executed. With this configuration, the functions of the lighting device 190 can be inspected while the vehicle 100 is traveling by unmanned driving. The functions of the lighting device 190 can thus be inspected without stopping the vehicle 100. This improves the production efficiency and inspection efficiency of the vehicle 100. Moreover, the functions of the lighting device 190 can be inspected without an inspector having to get on the vehicle 100 and perform driving operations. Accordingly, the number of personnel for inspection of the lighting device 190 can be reduced.

The first vehicle 101 and the second vehicle 102 may not be vehicles capable of traveling by unmanned driving. Images may be captured during a period in which either or both of the first vehicle 101 and the second vehicle 102 are traveling under manned driving control. Even in such a configuration, the functions of the lighting device 190 mounted on the vehicle 100 can be inspected without using a dedicated site or dedicated equipment.

### Second embodiment

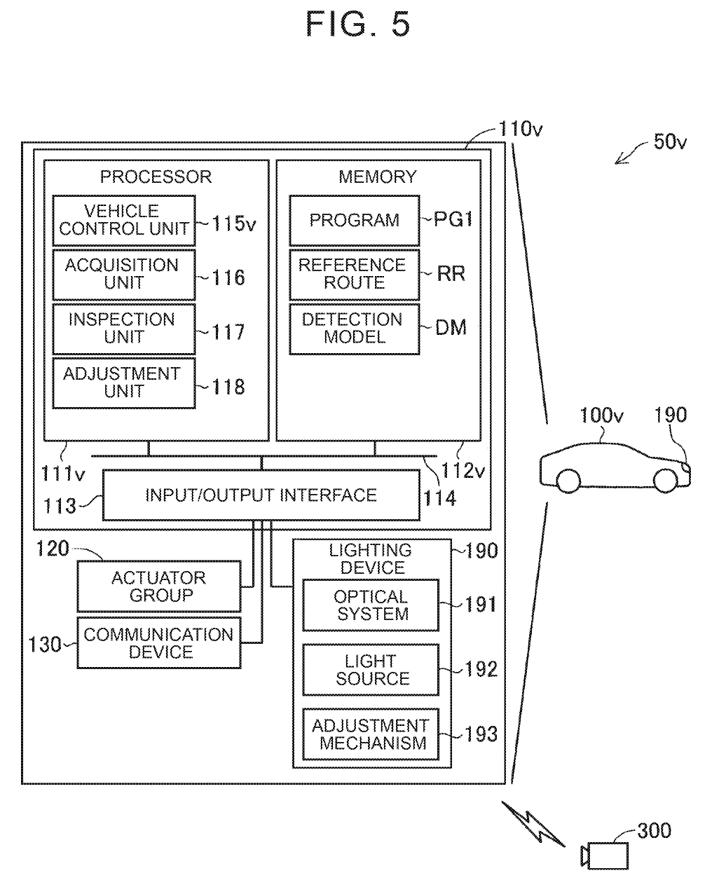

FIG. 5 illustrates a schematic configuration of an inspection system 50v according to a second embodiment. In the present embodiment, the inspection system 50v differs from the first embodiment in that it does not include the server 200. In the present embodiment, the vehicle 100v is capable of traveling under its own autonomous control. Other configurations are the same as those in the first embodiment unless otherwise specified.

In the present embodiment, a processor 111v of a vehicle control device 110v executes a program PG1 stored in a memory 112v to function as a vehicle control unit 115v, an acquisition unit 116, an inspection unit 117, and an adjustment unit 118. The vehicle control unit 115v acquires output results from sensors, generates a travel control signal by using the output results, and outputs the generated travel control signal to operate the actuator group 120, thereby enabling the vehicle 100v to travel under autonomous control. In the present embodiment, the memory 112v stores, in advance, the detection model DM and the reference route RR in addition to the program PG1. The acquisition unit 116 acquires a captured image from the imaging device 150. The inspection unit 117 inspects the function of the lighting device 190 by using the captured image. The adjustment unit 118 adjusts the optical system 191 of the lighting device 190 in accordance with the inspection result obtained by the inspection unit 117.

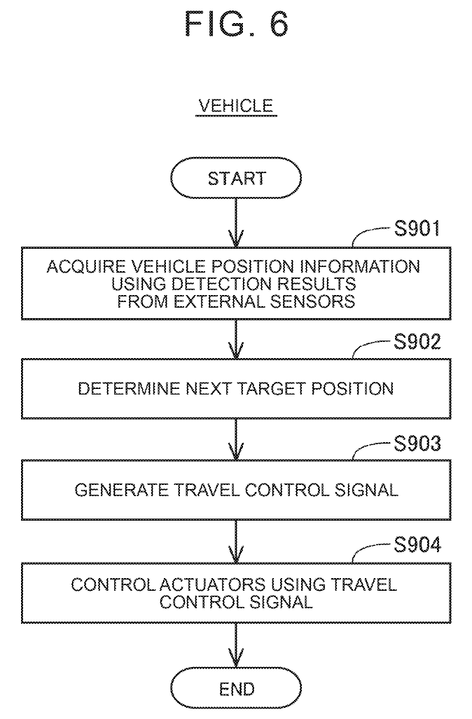

FIG. 6 is a flowchart illustrating a processing procedure for travel control of the vehicle 100v according to the second embodiment. In the processing procedure of FIG. 6, the processor 111v of the vehicle 100v functions as the vehicle control unit 115v by executing the program PG1.

In step S901, the processor 111v of the vehicle control device 110v acquires vehicle position information by using detection results output from the cameras serving as the external sensors 300. In step S902, the processor 111v determines a target position to which the vehicle 100v should travel next. In step S903, the processor 111v generates a travel control signal for causing the vehicle 100v to travel toward the determined target position. In step S904, the processor 111v controls the actuator group 120 by using the generated travel control signal, thereby causing the vehicle 100v to travel in accordance with parameters represented by the travel control signal. The processor 111v repeatedly performs, at predetermined intervals, acquisition of the vehicle position information, determination of the target position, generation of the travel control signal, and control of the actuators. The inspection system 50v of the present embodiment can cause the vehicle 100v to travel under its own autonomous control, without remotely controlling the vehicle 100v by the server 200.

### Other Embodiments

(C1) The second vehicle 102 may include an irradiation plate that is mounted at a position facing the lighting device 190 to be inspected and that is irradiated with the light beam BE emitted from the lighting device 190 to be inspected. The irradiation plate preferably has a color, reflectance, and surface shape such that, when captured by the imaging device 150, a range irradiated with the light beam BE emitted from the lighting device 190 can be easily identified. The irradiation plate is, for example, a white plate that has a surface shape smooth enough not to distort the light beam BE and has a reflectance low enough to suppress overexposure caused by excessively high brightness. In this case, the imaging device 150 is mounted on the first vehicle 101 at a position facing the irradiation plate, and indirectly captures the light beam BE emitted from the lighting device 190 by capturing the light beam BE incident on the irradiation plate. For example, when the lighting device 190 to be inspected is a headlamp mounted on the first vehicle 101, the irradiation plate is mounted on the rear RE of the second vehicle 102 that faces the headlamp mounted on the front FR of the first vehicle 101, in order to project the light beam BE emitted from the headlamp of the first vehicle 101. The imaging device 150 is mounted on the front FR of the first vehicle 101 in order to indirectly capture, via the irradiation plate provided on the rear RE of the second vehicle 102, the light beam BE emitted from the headlamp mounted on the front FR of the first vehicle 101. With this configuration, the functions of the lighting device 190 can be inspected by projecting, onto the irradiation plate, the light beam BE emitted from the lighting device 190 to be inspected and using a captured image of the light beam BE projected onto the irradiation plate. As a result, even in a case where the imaging device 150 is not mounted on the second vehicle 102, the inspection systems 50, 50v can acquire captured images and inspect the functions of the lighting device 190.

(C2) The inspection systems 50, 50v may include a changing unit that changes either or both of the height of the first vehicle 101 and the height of the second vehicle 102 by controlling an air suspension mounted on the vehicle 100. With this configuration, inspection accuracy can be improved by changing either or both of the height of the first vehicle 101 and the height of the second vehicle 102 to a height at which the imaging device 150 can easily capture the light beam BE.

(C3) In each of the above embodiments, at least part of the functions of the server 200 may be implemented as a function of the vehicle control devices 110, 110v. At least part of the functions of the vehicle control devices 110, 110v may be implemented as a function of the server 200. With this configuration, the configuration of the inspection systems 50, 50v can be changed as appropriate.

(C4) The inspection systems 50, 50v may be used at locations other than the factory FC that manufactures the vehicles 100, 100v. That is, the inspection systems 50, 50v may be used to inspect the vehicles 100, 100v after shipment. When the inspection systems 50, 50v are used at locations other than the factory FC, the term "factory" in the present disclosure may be replaced as appropriate with "work site" or "inspection site." With this configuration, even at locations other than the factory FC, such as vehicle inspection stations, the functions of the lighting device 190 mounted on the vehicles 100, 100v can be inspected without using a dedicated site or dedicated equipment.

(C5) In the above embodiments, the external sensors 300 are not limited to cameras and may be, for example, distance measuring devices. A distance measuring device may be, for example, a light detection and ranging (LiDAR) device. In this case, the detection result output by the external sensor 300 may be three-dimensional point cloud data representing the vehicles 100, 100v. In this case, the server 200 or the vehicles 100, 100v may acquire the vehicle position information by performing template matching using the three-dimensional point cloud data as detection results and reference point cloud data prepared in advance.

(C6) In the first embodiment, the server 200 executes processing from acquisition of the vehicle position information to generation of the travel control signal. However, at least part of the processing from acquisition of the vehicle position information to generation of the travel control signal may be executed by the vehicle 100. For example, the following configurations (1) to (3) may be adopted.
(1) The server 200 may acquire the vehicle position information, determine a target position to which the vehicle 100 should travel next, and generate a route from the current position of the vehicle 100 represented in the acquired vehicle position information to the target position. The server 200 may generate a route from the current position to the target position located between the current position and a destination or may generate a route to the destination. The server 200 may transmit the generated route to the vehicle 100. The vehicle 100 may generate a travel control signal such that the vehicle 100 travels along the route received from the server 200 and may control the actuator group 120 by using the generated travel control signal.
(2) The server 200 may acquire the vehicle position information and transmit the acquired vehicle position information to the vehicle 100. The vehicle 100 may determine a target position to which the vehicle 100 should travel next, generate a route from the current position of the vehicle 100 represented in the received vehicle position information to the target position, generate a travel control signal such that the vehicle 100 travels along the generated route, and control the actuator group 120 by using the generated travel control signal.
(3) In each of the configurations (1) and (2), an internal sensor may be mounted on the vehicle 100, and detection results output from the internal sensor may be used for either or both of route generation and travel control signal generation. The internal sensor is a sensor mounted on the vehicle 100. The internal sensor may include, for example, a sensor that detects the motion state of the vehicle 100, a sensor that detects the operating state of various parts of the vehicle 100, and a sensor that detects the surroundings of the vehicle 100. Specifically, the internal sensor may include, for example, a camera, a LiDAR sensor, a millimeter-wave radar, an ultrasonic sensor, a Global Positioning System (GPS) sensor, an acceleration sensor, and a gyro sensor. For example, in the configuration (1), the server 200 may acquire detection results from the internal sensor and reflect the detection results of the internal sensor in the route when generating the route. In the configuration (1), the vehicle 100 may acquire detection results from the internal sensor and reflect the detection results of the internal sensor in the travel control signal when generating the travel control signal. In the configuration (2), the vehicle 100 may acquire detection results from the internal sensor and reflect the detection results of the internal sensor in the route when generating the route. In the configuration (2), the vehicle 100 may acquire detection results from the internal sensor and reflect the detection results of the internal sensor in the travel control signal when generating the travel control signal.

(C7) In the second embodiment, an internal sensor may be mounted on the vehicle 100v, and detection results output from the internal sensor may be used for either or both of route generation and travel control signal generation. For example, the vehicle 100v may acquire detection results from the internal sensor and reflect the detection results of the internal sensor in the route when generating the route. The vehicle 100v may acquire detection results from the internal sensor and reflect the detection results of the internal sensor in the travel control signal when generating the travel control signal.

(C8) In the second embodiment, the vehicle 100v acquires the vehicle position information by using detection results from the external sensors 300. However, an internal sensor may be mounted on the vehicle 100v, and the vehicle 100v may acquire the vehicle position information by using detection results from the internal sensor, determine a target position to which the vehicle 100v should travel next, generate a route from the current position of the vehicle 100v represented in the acquired vehicle position information to the target position, generate a travel control signal for causing the vehicle 100v to travel along the generated route, and control the actuator group 120 by using the generated travel control signal. In this case, the vehicle 100v can travel without using any detection results from the external sensors 300. The vehicle 100v may acquire from outside the vehicle 100v, a target arrival time and traffic congestion information, and reflect the target arrival time and the traffic congestion information in either or both of the route and the travel control signal. All of the functional configurations of the inspection system 50v may be provided in the vehicle 100v. That is, the processing implemented by the inspection system 50v in the present disclosure may be implemented by the vehicle 100v alone.

(C9) In the first embodiment, the server 200 automatically generates the travel control signal to be transmitted to the vehicle 100. However, the server 200 may generate the travel control signal to be transmitted to the vehicle 100, in accordance with operations performed by an external operator located outside the vehicle 100. For example, an external operator may operate an operating device including: a display that displays captured images output from the external sensors 300; a steering wheel, an accelerator pedal, and a brake pedal that remotely operate the vehicle 100; and a communication device that communicates with the server 200 via wired or wireless communication. The server 200 may generate a travel control signal corresponding to operations input to the operating device.

(C10) In each of the above embodiments, the vehicles 100, 100v may be any vehicles as long as they include a configuration that enables the vehicles 100, 100V to travel by unmanned driving. For example, the vehicles 100, 100v may be in the form of a platform having the configuration described below. Specifically, the vehicles 100, 100vmay be any vehicles as long as they include at least the vehicle control devices 110, 110v and the actuator group 120 so as to implement the three functions of "moving," "turning," and "stopping" by unmanned driving. In a case where the vehicles 100, 100v acquire information from outside for unmanned driving, the vehicles 100, 100v may further include the communication device 130. That is, the vehicles 100, 100v that are capable of moving by unmanned driving may not be equipped with at least part of interior components, such as a driver's seat or a dashboard, installed, may not be equipped with at least part of exterior components, such as bumpers or fenders, and may not be equipped with a body shell. In this case, the remaining components such as the body shell may be installed on the vehicles 100, 100v before the vehicles 100, 100v are shipped from the factory FC, or the remaining components such as the body shell may be installed on the vehicles 100, 100v after the vehicles 100, 100v are shipped from the factory FC in a state where the remaining components such as the body shell are not yet installed on the vehicles 100, 100v. Each component may be installed from any direction, such as above, below, front, rear, right, or left of the vehicles 100, 100v, and each component may be installed from the same direction or from different directions. The positions of the vehicles 100, 100v having such a platform configuration may also be determined in the same manner as for the vehicles 100, 100v in the first embodiment.

(C11) The vehicles 100, 100v may be manufactured by combining a plurality of modules. The term "module" means a unit constituted by one or more components grouped according to the configuration or function of the vehicles 100, 100v. For example, the platform of the vehicles 100, 100v may be manufactured by combining a front module that constitutes the front part of the platform, a center module that constitutes the central part of the platform, and a rear module that constitutes the rear part of the platform. The number of modules constituting the platform is not limited to three, and may be two or less, or four or more. In addition to or instead of the platform, a portion of the vehicles 100, 100v different from the platform may be modularized. Various modules may include any exterior components such as bumpers and grilles, and any interior components such as seats and consoles. Not only the vehicles 100, 100v but also mobile bodies of any form may be manufactured by combining a plurality of modules. Such modules may be manufactured by joining a plurality of components by, for example, welding or fasteners, or may be manufactured by integrally molding at least part of the module as a single component by casting. A molding method in which at least part of the module is integrally molded as a single component is also referred to as giga-casting or mega-casting. By using giga-casting, each part of a mobile body that has conventionally been formed by joining a plurality of components can be formed as a single component. For example, the front module, the center module, and the rear module may be manufactured by using giga-casting.

(C12) Transporting the vehicles 100, 100v by unmanned driving of the vehicles 100, 100v is also referred to as "self-transport." The configuration for implementing self-transport is also referred to as a "remote control auto driving system." A production method in which the vehicles 100, 100v are produced by using self-transport is also referred to as "self-propelled production." In self-propelled production, for example, at least part of the transport of the vehicles 100, 100v in the factory FC where the vehicles 100, 100v are manufactured is implemented by self-transport.

(C13) In each of the above embodiments, part or all of the functions and processing implemented by software may be implemented by hardware. Part or all of the functions and processing implemented by hardware may be implemented by software. As hardware for implementing the various functions in the above embodiments, various circuits such as integrated circuits and discrete circuits may be used.

The present disclosure is not limited to the embodiments described above, and can be implemented with various configurations without departing from the spirit and scope of the disclosure. For example, the technical features of the embodiments corresponding to the technical features of the aspects described in the section "SUMMARY OF THE DISCLOSURE" may be replaced or combined as appropriate in order to address part or all of the issues described above or to achieve part or all of the effects described above. Unless a technical feature is described in this specification as being essential, it may be omitted as appropriate.

What is claimed is:

1. An inspection system comprising:
a first mobile body including a lighting device to be inspected;
a second mobile body that moves either in front of or behind the first mobile body;
an imaging device configured to capture a light beam emitted from the lighting device and output a captured image, the imaging device being mounted on either the first mobile body or the second mobile body;
an acquisition unit configured to acquire the captured image; and
an inspection unit configured to inspect a function of the lighting device by using the captured image.

2. The inspection system according to claim 1, further comprising an adjustment unit configured to adjust an optical system of the lighting device in accordance with an inspection result obtained by the inspection unit.

3. The inspection system according to claim 1, wherein:
the imaging device is mounted on the second mobile body at a position facing the lighting device; and
the imaging device is configured to directly capture the light beam emitted from the lighting device.

4. The inspection system according to claim 1, wherein:
the second mobile body includes an irradiation plate that is mounted at a position facing the lighting device and that is irradiated with the light beam;
the imaging device is mounted on the first mobile body at a position facing the irradiation plate; and
the imaging device is configured to indirectly capture the light beam emitted from the lighting device by capturing the light beam incident on the irradiation plate.

5. The inspection system according to claim 1, wherein:
either or both of the first mobile body and the second mobile body are configured to move by unmanned driving; and
the captured image is captured during a period in which control for the unmanned driving is being executed.
